(19) United States
(12) Patent Application Publication
(10) Pub. No.: US 2017/0333820 A1
(43) Pub. Date: Nov. 23, 2017

(54) RECIRCULATION FILTER FOR AN ENCLOSURE

(71) Applicant: Donaldson Company, Inc., Minneapolis, MN (US)

(72) Inventor: Daniel L. Tuma, St. Paul, MN (US)

(21) Appl. No.: 15/523,214

(22) PCT Filed: Oct. 29, 2015
(86) PCT No.: PCT/US2015/057950

§ 371 Date: Apr. 28, 2017

Related U.S. Application Data
(60) Provisional application No. 62/073,822, filed on Oct. 31, 2014.

(51) Int. Cl. B01D 46/00; B01D 53/04; B01D 39/16; B01D 46/24; G11B 33/14

(52) U.S. Cl. CPC B01D 46/0001; B01D 46/0036; B01D 46/2403; G11B 33/146; B01D 39/1607; B01D 53/0407; B01D 2253/102; B01D 2279/45; B01D 2239/0407

(57) ABSTRACT

The technology disclosed herein relates to filter assemblies and methods of making filter assemblies. One filter assembly has a first sheet of filter media having a first perimeter region and a second sheet of filter media having a second perimeter region. The first perimeter region and the second perimeter region are bonded in a rim region. A plurality of adsorbent beads are disposed between the first sheet of filter media and the second layer of filter media, and a substantial portion of the plurality of adsorbent beads are unbonded. Other embodiments are also described.

This application is being filed as a PCT International Patent Application on Oct. 30, 2015, in the name of DONALDSON COMPANY, INC., a U.S. national corporation, applicant for the designation of all countries, and Daniel L. Tuma, a U.S. Citizen, inventor for the designation of all countries, and claims priority to U.S. Provisional Patent Application No. 62/073,822, filed on Oct. 31, 2014, the content of which is herein incorporated by reference in its entirety.

### TECHNOLOGICAL FIELD

The present technology is directed to filters for use in electronic enclosures. In particular, the technology is directed to filters for removing contaminants circulating within the interior of an electronic enclosure.

### BACKGROUND

Contaminants within an electronic enclosure, such as a hard disk drive enclosure, can reduce the efficiency and longevity of the components within the enclosure. Contaminants can include chemicals and particulates, and can enter the hard drive enclosure from external sources, or be generated within the enclosure during manufacture or use. The contaminants can gradually damage the drive, resulting in deterioration of drive performance and even complete failure of the drive. Consequently, data storage systems such as hard disk drives typically have one or more filters capable of removing or preventing entry of particulate and/or chemical contaminants in the air within the disk drive enclosure. One type of such filter is a recirculation filter, which is generally placed such that it can filter out contaminants from the path of airflow caused by rotation of one or more disks within the disk drive. Although existing recirculation filters can remove many contaminants, a need exists for improved performance at removing certain contaminants, in particular, chemical contaminants.

### BRIEF DESCRIPTION OF THE DRAWINGS

The current technology will be more fully explained with reference to the following drawings.

FIG. 1 is a simplified perspective view of a disk drive assembly, showing the top of the disk drive assembly removed.

FIG. 2 is a cross sectional schematic view of a filter assembly from a first side.

FIG. 3 is a cross sectional schematic view of the filter assembly consistent with the embodiment depicted in FIG. 2, viewed from a second side.

FIG. 4 is a cross sectional schematic first-side view of a filter assembly as described herein, viewed from a first side.

FIG. 5 is a cross sectional schematic second-side view of a filter assembly consistent with the embodiment depicted in FIG. 4, viewed from a second side.

FIG. 6 is a cross sectional schematic view of another filter assembly as described herein, viewed from a first side.

FIG. 7 is a cross sectional schematic view of a filter assembly consistent with FIG. 6, viewed from a second side.

FIG. 8 is a schematic of a partial top plan view of a disk drive assembly containing a filter assembly constructed and arranged in accordance with an example implementation of the currently disclosed technology.

FIG. 9 is a graph showing a performance comparison among three filter concepts.

FIGS. 10A-10F are schematic depictions showing a method of making a filter assembly as described herein.

FIG. 11 is a cross sectional schematic first-side view of yet another filter assembly as described herein, viewed from a first side.

FIG. 12 is a cross sectional schematic second-side view of a filter assembly consistent with the embodiment depicted in FIG. 11, viewed from a second side.

While principles of the current technology are amenable to various modifications and alternative forms, specifics thereof have been shown by way of example in the drawings and will be described in detail. It should be understood, however, that the intention is not to limit the currently-described technology to the particular embodiments described. On the contrary, the intention is to cover all modifications, equivalents, and alternatives falling within the spirit and scope of the disclosure and claims.

### DETAILED DESCRIPTION

Various filtering systems are known that are used to reduce or remove contaminants from disk drive assemblies, as well as other electronic enclosures. In particular, recirculation filters are often used to reduce or remove particulate and/or chemical contaminants that have entered a disk drive enclosure or been generated during use of the disk drive. A typical recirculation filter has a filter element that is positioned in the path of air currents induced by disk rotation such that contaminants present in the air current are subject to filtration.

In an example embodiment, the filter assembly has a filter structure with first sheet of filter media and a second sheet of filter media bonded to each other about their respective perimeter regions, and an adsorbent material disposed between the layers of filter media.

Generally, a support layer such as a permeable scrim material can form at least a portion of the filter structure. A filter media is disposed within the internal recess of the filter assembly, the filter media at least partially covering the support layer. In an example embodiment the filter media will overlay all or most of the support layer. In another example embodiment the support layer is embedded within the filter media. In some embodiments the filter media and the support layer are combined together to form a layer of filter media before production of the filter assembly (such as, for example, by lamination, heat bonding, or light calendaring) and subsequently formed into a media structure that creates at least a portion of the filter assembly.

In some embodiments, the support layer is a permeable scrim material that comprises a woven or non-woven material, such as polypropylene fibers. The support layer can have, for example, a permeability of between about 100 ft./min. at 0.5 inches of water and about 800 ft./min. at 0.5 inches of water in some embodiments. In some embodiments the support layer has a permeability of about 250 ft./min. at 0.5 inches of water and about 600 ft./min. at 0.5 inches of water. In yet other implementations the support layer has a permeability of about 300 ft./min. at 0.5 inches of water and about 500 ft./min at 0.5 inches of water, It will be understood that suitable support layer material can have, for example, a permeability of more than 100 ft./min. at 0.5 inches of water; more than 250 ft./min. at 0.5 inches of water; or more than 300 ft./min. at 0.5 inches of water. Suitable support layer material can have, for example, a permeability of less than about 800 ft./min. at 0.5 inches of water in some embodiments; less than 600 ft./min. at 0.5 inches of water in some embodiments; or less than 500 ft./min. at 0.5 inches of water in some embodiments.

The filter media consistent with the technology disclosed herein can be electrostatic in nature. In a variety of embodiments the filter media has a Figure of Merit greater than about 60. The Figure of Merit can be calculated to evaluate the ability of a filter or filter medium to provide sufficient clarification of a stream in various filtration environments including, relevant to the present disclosure, electronics housings. The Figure of Merit is calculated based upon a fractional efficiency determined for particles having a size of 0.3 μm in an air flow having a velocity of 10.5 ft./min. and a Frazier permeability at 0.5 inches H₂O.

The Figure of Merit, discussed more fully hereinafter, is similar to another property called Figure of Merit Prime (FOM′). FOM′ is defined as the fractional efficiency of a medium divided by its resistance. The equation describing the Figure of Merit Prime is:

$${FOM}^{ ′} = \frac{fractional efficiency}{resistance}$$

The fractional efficiency is the fraction or percentage of particles of a specified size which are removed from air passing through the medium at a specified air flow velocity. Applicants have found it convenient to determine fractional efficiency based upon a particle size of 0.3 μm and an airflow velocity of 10.5 ft./min. It should be understood that the particle size of 0.3 μm actually reflects a distribution of particles of between 0.3 and 0.4 μm.

The resistance is the slope of the pressure drop of the filter as a function of the air flow velocity. For convenience, the units chosen are inches of water for pressure drop and feet per minute for air flow velocity. The units for resistance are then inches H₂O/ft./min.

Since the resistance for a given filter medium can be difficult to obtain, the Frazier permeability is used as a convenient substitute. The Frazier permeability is the linear air flow velocity through a medium at a half inch of water pressure (0.5 “H₂O). The Figure of Merit (FOM) is:

FOM=fractional efficiency×2×Frazier permeability

The Frazier permeability is calculated from measurements of pressure drop (ΔP) in units of inches of water (“H₂O) at a specified airflow velocity or volumetric flow rate. The Frazier permeability is estimated by multiplying 0.5 times the airflow velocity and dividing by the pressure drop. It should be appreciated that the volumetric flow rate can be converted to an air flow velocity by dividing by the area of the medium, and that the air flow velocity should be converted to feet per minute (ft./min.).

For predicting the FOM of a combination of layers that have not yet been assembled as a filter media, the fractional efficiency can be calculated as the total penetration of the individual layers. The total Frazier permeability of the combination of layers is the reciprocal of the sum of the reciprocals of the Frazier permeabilities of each individual layer. The total FOM is then the total penetration multiplied by the total Frazier permeability multiplied by 2.

For recirculation filters, it can be desirable to provide a FOM that is as high as possible. A high FOM corresponds with high permeability, which is important for a filter placed in a stream of circulating air. Recirculation filters consistent with the technology disclosed herein have a FOM value of at least about 60, and in some embodiments at least about 150. Generally, the FOM can be between about 50 and about 250, or even between about 150 and about 200.

The filter media can contain various fibers, and is optionally a mixed fiber media comprising polypropylene and acrylic fibers. The filter media has, for example, a permeability of between about 250 ft./min. at 0.5 inches of water and about 750 ft./min. at 0.5 inches of water. The filter media can have a filtering efficiency of about 20% to about 99.99% for 0.1 to 0.3 micron particulate contaminants in some embodiments. Suitable filter media can, for example, have a filtering efficiency of greater than 20% for 0.1 to 0.3 micron particulate contaminants; greater than 40% for 0.1 to 0.3 micron particulate contaminants; or greater than 60% for 0.1 to 0.3 micron particulate contaminants. The filter media can have in some example implementations a filtering efficiency of less than 99.99% for 0.1 to 0.3 micron particulate contaminants; less than 80% for 0.1 to 0.3 micron particulate contaminants; or less than 60% for 0.1 to 0.3 micron particulate contaminants.

In a variety of embodiments, the filtration media consistent with the technology closed herein has electrostatic fibers. The term “electrostatic fibers,” as used herein, refers to fibers that contain an electric charge. One advantage of including electrostatic fibers in the filter assembly 200 is that the filter is not only able to mechanically trap contaminants, but is also able to exert an electrostatic force on contaminants that contain electric charges, thereby increasing the amount of contaminants that are removed from the airstream. The electrostatic media can be triboelectric media, electret media, or any other media that can be charged, or that depends on charging as the main mechanism for particle removal. In example embodiments, the electrostatic media has triboelectric fibers. Triboelectric fibers are known and can be formed, for example, using a mixture of (1) polyolefin fibers such as polyethylene, polypropylene or ethylene and propylene copolymers, with (2) fibers of another polymer, for example, fibers containing hydrocarbon functions substituted by halogen atoms, such as chlorine or polyacrylonitrile fibers. In general, the polyolefin fibers and the other polymer fibers are included in the electrostatic media at a weight ratio between about 60:40 or about 20:80 or about 30:70.

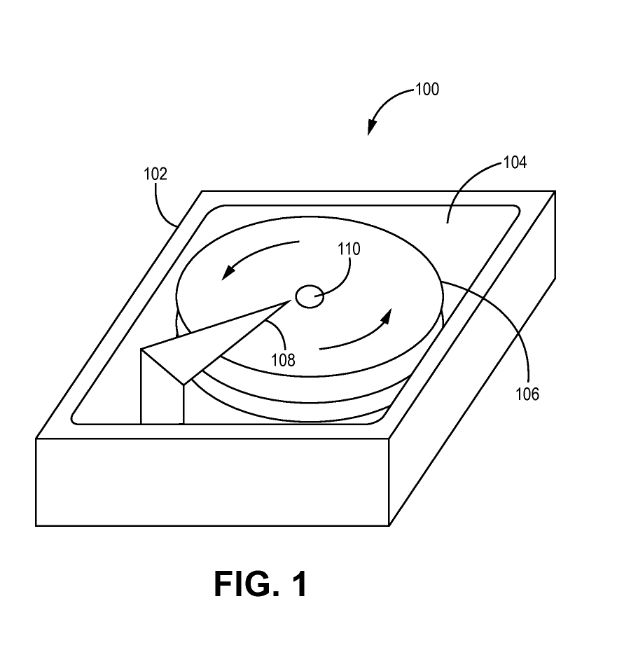

Now, in reference to the drawings, FIG. 1 is a simplified perspective representation of a disk drive 100. The disk drive 100 has a housing body 102 that defines an enclosure 104. In an example embodiment, at least one disk 106 is rotatably mounted within the enclosure 104. The rotation of the disk is shown by arrows (although opposite rotation is alternatively possible), where the rotation of the disk induces airflow within the enclosure 104. Other disk drive components, such as a read-write head and wiring can be incorporated into an armature 108.

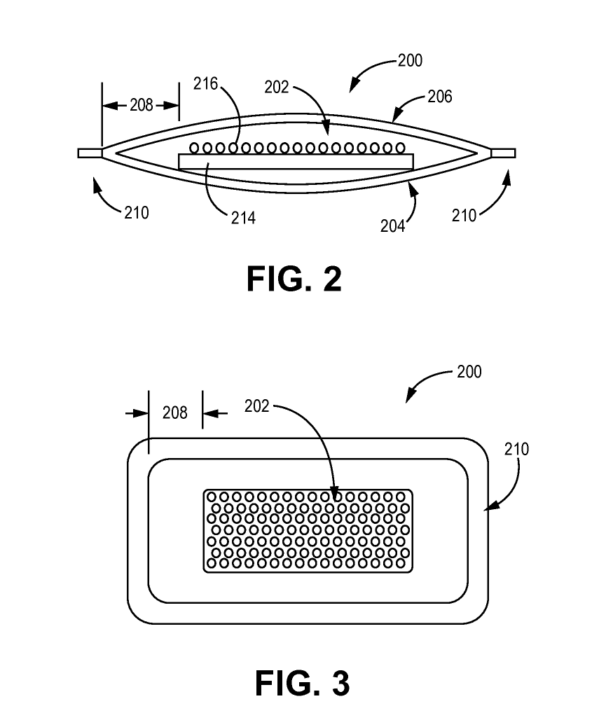

FIGS. 2 and 3 are cross sectional views of a known filter assembly 200 that is disclosed herein for comparison purposes. A carbon element 202, which can be referred to as an adsorbent element, is disposed between a first sheet 206 having a first support layer and a first layer of electrostatic filter media, and a second sheet 204 having a second support layer and second layer of electrostatic filter media, and the carbon element 202 fills a portion of a cavity defined by the first sheet and second sheet 206, 204. The carbon element 202 is generally configured to help filter the air passing through the filter assembly 200 and has a scrim layer 214 with a plurality of carbon beads 216 adhered thereto.

A perimeter region of the first sheet 206 is welded with a perimeter region of the second sheet 204 around the carbon element 202, resulting in a clearance 208. The clearance 208 describes a portion of the filter between the weld 210 and the carbon element 202. In the design shown in FIGS. 2 and 3 the carbon element is generally sized smaller than the media area due to the clearance 208 required for manufacturing processes. The clearance 208 can ensure that during the welding process a portion of the carbon element 202 does not get welded between the layers. If a portion of the carbon element 202 becomes welded between the layers, the filter could be rejected for having a defect. If the filter is not rejected and is used in an electronics enclosure, a portion of the carbon element 202 could become particle contamination for the enclosure. The reduction in the carbon element 202 area can become even greater as the outside dimensions of the filter get smaller. As the filter gets smaller it can become more difficult to get the relatively flat media to flex over the carbon and result in the need to use a thinner carbon element 202.

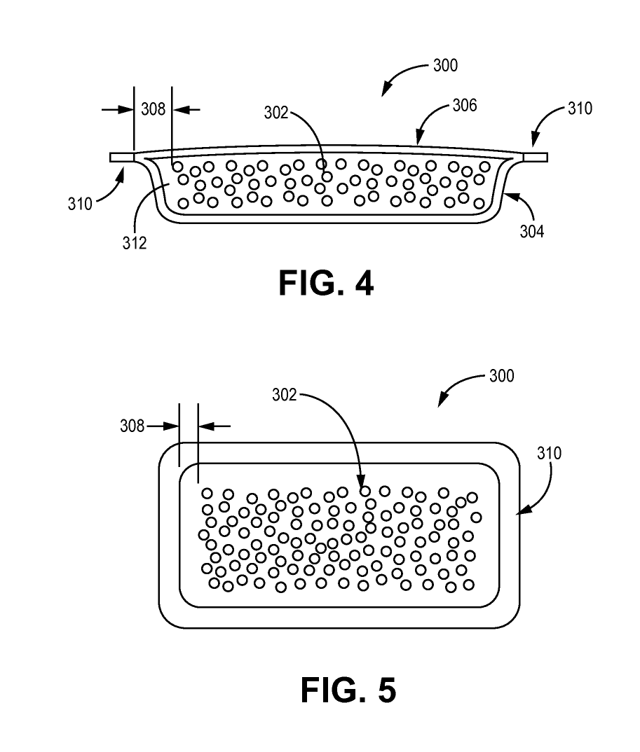

FIGS. 4 and 5 are cross sectional views of a filter assembly 300 consistent with the technology disclosed herein having at least a first sheet 304, a second sheet 306, and an adsorbent 302 disposed in a cavity 312 defined between the first sheet 304 and the second sheet 306. The first sheet 304 generally has a first perimeter region that can be bonded to a perimeter region of the second sheet 306 to form a rim region 310. In a variety of embodiment, the rim region 310 is a weld area from heat welding or ultrasonic welding, as examples.

The filter assembly 300 is generally configured to filter particles and chemical contaminants from air. In a variety of embodiments the filter assembly 300 is configured to be positioned in an electronics enclosure to filter the air therein. In some embodiments the filter assembly 300 is configured to be positioned in a disk drive to filter the air within the disk drive. Other uses for the filter assembly will be appreciated.

In a variety of embodiments, the first sheet 304 and the second sheet 306 are generally layers of filter media that are consistent with the types of filter media already described herein. The first sheet 304 and the second sheet 306 can be configured to filter particulates from the air. In a variety of embodiments, the first sheet 304 can generally be constructed of a first layer of filter media having a first support layer coupled thereto. Similarly, the second sheet 306 can generally be constructed of a second layer of filter media having a second support layer coupled thereto. The first support layer and the second support layer can be consistent with support layers already described herein, and in at least one embodiment, the first support layer and the second support layer are constructed of the same material. It will generally be understood that any number of layers can be coupled to form the first sheet 304 and the second sheet 306 so long as the desired filter parameters are achieved based on the context of the filter, such as permeability, efficiency, FOM, pressure drop, etc.

In some embodiments, the first sheet 304, the second sheet 306, or both sheets 304, 306 are at least partially constructed of electrostatic fibers, previously discussed. In at least one embodiment, the second sheet 306 is the same material as the first sheet 304. In another embodiment, the first sheet 304 and the second sheet 306 are different materials. For example, in one embodiment, the second sheet 306 can be a screen layer that is welded, fused or otherwise bonded to the first sheet 304. In some such embodiments, the first sheet 304 can have an electrostatic filter media layer and a support layer that are welded together, and the screen layer can be welded to the layer of filter media in the rim region 310. The screen layer can generally allow air to pass through the screen layer and into the cavity 312 of the filter assembly 300. The screen layer can additionally provide support, such as to aid the filter assembly 300 in keeping a desired configuration.

In the current embodiment, the first sheet 304 at least partially defines the shape of the cavity 312. The cavity 312 can be substantially self-supporting in at least one example embodiment, but is not substantially self-supporting in another example embodiment. The term “substantially self-supporting” is used to mean that the first sheet 304 has the ability to retain the existence of the cavity 312 against atmospheric gravity. In the current embodiment, the second sheet 306 is substantially planar, meaning that the structure of the second sheet 306 itself does not define a cavity; rather, the structure of the second sheet 306 encloses the cavity defined by the first sheet of filter media 304.

The adsorbent 302 can be disposed between the first sheet 304 and the second sheet 306 within the cavity 312. The adsorbent 302 is generally configured to adsorb chemical contaminants from the air within the environment of the filter assembly 300. The adsorbent material can be a physisorbent or chemisorbent material, such as, for example, a desiccant (i.e., a material that adsorbs or absorbs water or water vapor) or a material that adsorbs or absorbs volatile organic compounds, acid gas, or both. Suitable adsorbent materials include, for example, activated carbon, activated alumina, molecular sieves, silica gels, potassium permanganate, calcium carbonate, potassium carbonate, sodium carbonate, calcium sulfate, or mixtures thereof. The adsorbent 302 is generally a plurality of adsorbent beads. In a variety of embodiments, the adsorbent 302 is a plurality of activated carbon beads. The adsorbent beads can range in size from about 0.2 mm to about 1.1 mm, 0.4 mm to about 1.0 mm, and about 0.3 mm to about 0.9 mm. In one embodiment the adsorbent beads will have an average size of about 0.3 mm to about 0.8 mm, or about 0.6 mm.

In some embodiments a substantial portion of the plurality of adsorbent beads are unbonded, meaning that a substantial portion of the adsorbent beads are unbonded to each other and are unbonded to any other element in the filter assembly. In at least one embodiment, each of the plurality of adsorbent beads are completely unbonded. By a “substantial portion” it is meant that at least 70%, 80%, 90%, 95% or even 98% of the adsorbent beads are unbonded. Unbonded beads have the relative advantages of increasing the available surface area for adsorption, increasing the permeability of the filter itself, and can having low dusting, for example. A clearance 308 defined by the filter assembly 300 as shown in FIGS. 4 and 5 can be reduced and more adsorbent 302 can be disposed within the cavity as compared to the filter element depicted in FIGS. 2 and 3. In an embodiment, the filter assembly 300 can be about 8.5 mm×20 mm and can be about 4 mm thick. In embodiments having carbon beads as the adsorbent 302, the mass of the carbon beads can be at least 35 mg and generally no more than about 55 mg, such as about 45 mg. In an embodiment, the filter assembly 300 can be about 4 mm×15.5 mm and comprise carbon beads with a mass of at least 20 mg and generally no more than about 45 mg, such as about 33 mg.

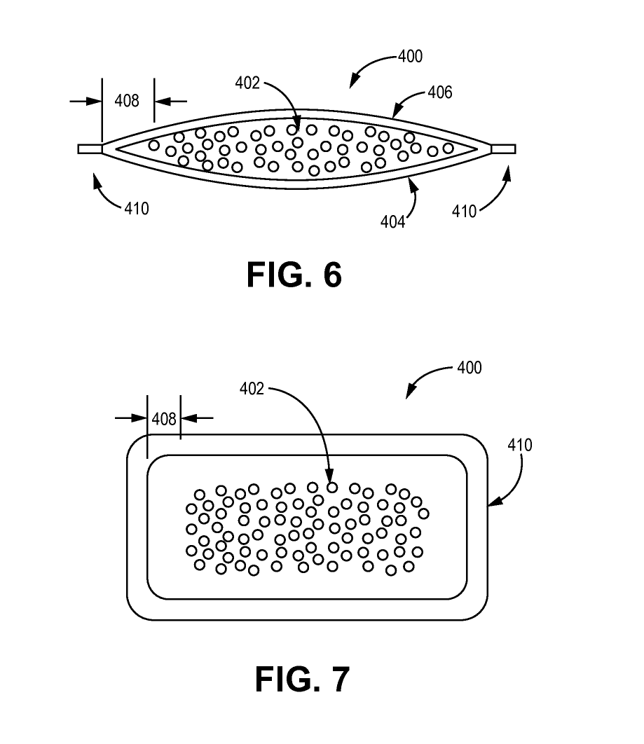

FIGS. 6 and 7 are cross sectional views of an alternate filter assembly 400 consistent with the technology disclosed herein. The filter assembly 400 has at least a first sheet 404, a second sheet 406, and an adsorbent 402 disposed in a cavity 412 defined between the first sheet 404 and the second sheet 406. The first sheet 404 generally has a first perimeter region that can be bonded to a perimeter region of the second sheet 406 to form a rim region 410. In a variety of embodiments, the rim region 410 is a weld area from heat welding or ultrasonic welding, as examples. The filter assembly 400 is generally configured to filter air within an electronics enclosure, such as a disk drive.

Similar to the embodiment described relative to FIGS. 4 and 5, in the current embodiment the first sheet 404 and the second sheet 406 generally each have at least one layer of filter media, consistent with filter media already described herein. In a variety of embodiments, the filter media can be electrostatic in nature. The first sheet 404 and the second sheet 406 can also have one or more support layers that can be consistent with support layers already described herein. The first sheet 404 and the second sheet 406 can be the same or different materials.

In the current embodiment, the first sheet 404 and the second sheet 406 cumulatively defines the shape of the cavity 412. In some embodiments, only one of the first sheet and second sheet define a substantially self-supporting cavity. In some embodiments, both of the first sheet and second sheet define a substantially self-supporting cavity. In some other embodiments, neither of the first sheet nor second sheet defines a substantially self-supporting cavity. The first sheet 404 and second sheet 406 are similarly shaped in the current embodiment. The term “similarly shaped” is intended to mean that the first sheet 404 and second sheet 406 each define cavity structures having volumes that are within 5%, 10%, or even 15% of each other. In some embodiments the first sheet and the second sheet are not considered “similarly shaped.”

The adsorbent 402 disposed between the first sheet 404 and second sheet 406 is generally a plurality of adsorbent beads, which can be activated carbon beads in a variety of embodiments that are consistent with the embodiment described above with reference to FIGS. 4-5. In a variety of embodiments a substantial portion of the plurality of adsorbent beads are unbonded.

The filter constructions consistent with the technology disclosed herein allow for a relative increase in the amount of adsorbent material that can be contained in the filter (such as activated carbon) while preserving a relatively compact size, and while improving filter performance. In particular, in certain embodiments, the filters described herein can result in increases in activated carbon quantity while substantially preserving airflow through the filter, thereby allowing for lower contaminant levels within an enclosure and maintenance of those lower concentration levels for an extended time period.

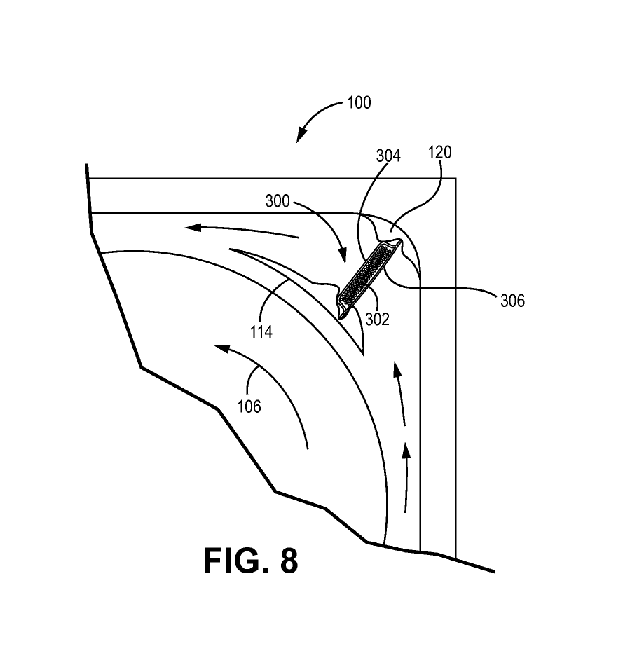

FIG. 8 depicts an example implementation of a filter assembly 300 consistent with the technology disclosed herein. The filter assembly 300 is generally consistent with the embodiment depicted in FIGS. 4-5 and is installed within a housing defining an electronic enclosure 100 (only a corner of the enclosure 100 is depicted). The filter assembly 300 has a first sheet 304, a second sheet 306, and adsorbent 302 disposed between the first sheet 304 and the second sheet 306. The filter assembly is oriented so that the surface area of the second sheet 306 is facing into the air stream generated by a rotating disk 106 (depicted directionally by arrows). The electronic enclosure 100 has a filter mount 120 that is configured to receive the filter assembly 300. In the embodiment shown, a baffle 114 is present to aid in the direction of air into the second sheet 306 of the filter assembly 300, and the baffle 114 at least partially defines the filter mount 120. The filter assembly 300 can be placed within the electronic enclosure such that the baffle 114 directs air into and through the second sheet 306. In certain implementations the baffle 114, along with any mounting elements, or other portions of the housing, form a channel that directs air into the second sheet 306. In other implementations the filter assembly 300 is configured to be positioned in a flowing air stream within an electronics enclosure that lacks a single defined channel directing airflow through the filter assembly 300, or an open-sided channel can be formed within the enclosure that partially directs air through the filter assembly 300.

### Test Results

In an example filter construction consistent with the comparative example shown in FIGS. 2-3 and described herein, a first recirculation filter was constructed having a first sheet and a second sheet that were bonded about their respective perimeters. A carbon element, having a scrim layer with carbon beads coupled thereto, was disposed between the first sheet and second sheet. Each of the first sheet and second sheet were constructed of a layer of electrostatic filter media and a polypropylene scrim layer. The first recirculation filter had a width of 15.4 mm, a height of 8.9 mm, and a thickness of 2.8 mm. This first recirculation filter had a welded perimeter of about 1 mm. This first recirculation filter had an active filtering area of 13.4 mm×6.9 mm, or approximately 92 mm², where the active filtering area was measured based on the flow face area of the filter that was available for filtration within the bonded perimeter. The flow face of the recirculation filter is a filter surface that is configured to directly receive airflow during filtration. The carbon element had a width of 8.1 mm, a height 3.6 mm, and an adsorbent face area of approximately 29 mm², where the adsorbent face area is the measurement of the area of the filter containing adsorbent (e.g. carbon beads), measured from the flow face of the recirculation filter. As such, for the first example recirculation filter, the adsorbent face area was equivalent to the area of the carbon element itself. The area of the carbon element was approximately 35% of the active filtering area of the recirculation filter. The adsorbent element had a carbon mass of 8 mg.

A second example recirculation filter was made in accordance with the embodiment depicted in FIGS. 4-5. The second recirculation filter had a first sheet and the second sheet that were joined about their respective perimeters. Each of the first sheet and second sheet were constructed of a layer of electrostatic filter media and a polypropylene scrim layer. The first sheet defined a cavity recessed from its perimeter, and the cavity was defined between the first sheet and the second sheet. The second recirculation filter had a thickness of 4.8 mm. The cavity was about 10.9 mm wide×4.4 mm tall×3 mm deep. The cavity had a volume of about 120 mm³. The cavity was filled with 45 mg of unbonded activated carbon beads. The adsorbent face area of the carbon beads in the second recirculation filter was about 48 mm².

A third example recirculation filter was made in accordance with the embodiment depicted in FIGS. 6-7. The third recirculation filter had a first sheet and a second sheet that were joined about their respective perimeters. Each of the first sheet and second sheet were constructed of a layer of electrostatic filter material and a polypropylene scrim layer. The first sheet and second sheet mutually defined a cavity recessed from their respective perimeters. The third recirculation filter had an active filtering area of 13.4 mm×6.9 mm, or approximately 92 mm². The third recirculation filter had a thickness of about 2.8 mm. The inner cavity was filled with 12 mg of unbonded activated carbon beads. The cross-sectional area of the face of the carbon beads in the second recirculation filter was about 27 mm².

As described above, the adsorbent face area is used herein as a measurement of the area of the filter containing adsorbent measured from a flow face of the recirculation filter. The carbon face areas of the second and third example recirculation filters were measured using a VHX-1000 digital microscope from Keyence Corporation based in Itasca, Ill., having a Keyence VH-Z20R lens. A 60 W soft white incandescent light bulb was used as a backlight.

In particular, the microscope lens was positioned 90 degrees to the microscope base, facing a stage. The bulb was positioned 4.5 inches away from the microscope lens and pointed directly into the microscope lens. The filter was secured along one perimeter edge to the stage to stand vertically between the microscope lens and the bulb, one inch from the microscope. One face of the filter was positioned towards the microscope lens. The microscope was set to 20× magnification. No lighting options from the microscope were used. The incandescent bulb was illuminated and the brightness adjustment dial on the VHX-1000 console was set to allow the appropriate amount of light into the lens such that the perimeter of the filter became indistinguishable from the backlight, which amounted to approximately 75% of the maximum brightness setting. A free-form shape tool in the software of the VHX-1000 was used to calculate the adsorbent face area. A free-form shape was used to outline the perimeter of the carbon area, and the individual measurement option within the software was selected from the measurement menu to automatically calculate the area within the outlined perimeter.

Table 1, below, compares aspects of the first recirculation filter with the second and third recirculation filter examples, disclosed above:

TABLE l

| | | | Carbon | | Carbon | | |
|---|---|---|---|---|---|---|---|
| | | | Density in | Active | Density in | Lowest | |
| | Adsorbent | Adsorbent | Adsorbent | Filter | Active | Concentration | T₉₀ |
| | Amount | Face Area | Face Area | Face Area | Face Area | CCU | PCU |
| | (mg) | (mm²) | (g/m²) | (mm²) | (g/m²) | (ppm) | (sec) |
| First Filter | 8 | 29 | 280 | 92 | 90 | 23.33 | 12.50 |
| Second Filter | 45 | 48 | 940 | 92 | 490 | 6.58 | 12.36 |
| Third Filter | 12 | 29 | 410 | 92 | 130 | 13.67 | 13.81 |

The airflow restriction through the second and third recirculation filters is generally similar or less than the airflow restriction through the first recirculation filter. On one hand, the added mass of carbon in the second and third recirculation filters generally slightly increase the airflow restriction compared to the first recirculation filter; however, on the other hand, the increase of filtering area in the second recirculation filter can contribute to a reduction in the airflow restriction. Further, the elimination of the scrim adhered to the carbon beads (used in the first recirculation filter) can contribute to a relative decrease in airflow restriction in the second and third recirculation filters. The net airflow restriction through the second and third recirculation filters can be less than or approximately equal to the airflow restriction through first recirculation filter. The airflow restrictions through recirculation filters can be closely related to particle clean-up (PCU), therefore, in some implementations there is little to no reduction in particle cleanup for second recirculation filter with the increased amount of carbon, and no increase in airflow restriction.

The three example recirculation filters were subjected to PCU testing conducted to compare the average PCU time T₉₀ for each filter. The PCU performance can be calculated by running a particle cleanup test using a continuous particle introduction test method. This method provides a continuous flow of air with a controlled concentration of particles into a disk drive through an injection port and running the disk drive. Air is sampled from the drive through a sample port to get a concentration difference between the unfiltered air particle content and the filtered air particle content. The sample port used to sample the filtered air is slightly upstream of the filter being tested and the injection port is positioned approximately on the opposite side of the spindle of the rotating disk from the sample port. In use, a typical disk drive is sealed off from the outside environment with the exception of a breather port that allows for pressure equalization between the disk drive and the environment. For the currently described PCU test, however, the disk drive breather port is sealed off so that the airflow drawn into the drive is substantially equal to the flow being drawn out of the drive through the sample port by a particle counter.

The PCU test used 0.1μ polystyrene latex spheres (PSL) provided by Thermo Fischer Scientific Inc., based in Minneapolis, Minn., which are suspended in water and then atomized using a TSI 3076 Aerosol Generator from TSI, Inc. based in Shoreview, Minn. The aerosol stream is then dried using a diffusion dryer and then passed through a TSI 3012A Aerosol Neutralizer (also from TSI, Inc.). Since the output from the atomizer is greater than that necessary for the sample flow of the test, a tee pipe is used to exhaust the bulk of the airflow. A small portion of the airflow, however, is drawn into a disk drive through the injection port at flow rate Q. The particle counter used for this test is an Ultra-High Sensitivity Aerosol Spectrometer (UHSAS) manufactured by Droplet Measurement Technologies based in Boulder, Colo.

Since particles inside the disk drive can also be captured by other surfaces besides the filter, the drive is first tested without a filter to get baseline PCU measurements. Then, when testing the filter of-interest, the baseline can be factored in so that the PCU contribution of the filter can be calculated by the following equation:

$${τ}_{f} = \frac{V}{Q ( \frac{Ca ( w\_filter )}{Css ( w\_filter )} - \frac{Ca ( w \text{/} o\_filter )}{Css ( w \text{/} o\_filter )} )}$$

Where τ_{f}=Filter cleanup time constant (min),

V=Drive Volume (cm³),

Q=Sample Flow Rate (cm³/min),

C_{a(w}_{_}_{filter)}=Particle concentration into the drive with the filter (particles/cm³),

C_{ss(w}_{_}_{filter)}=Particle concentration steady state from the drive with the filter (particles/cm³),

C_{a(w/o}_{_}_{filter)}=Particle concentration into the drive without filter (particles/cm³), and

C_{ss(w/o}_{_}_{filter)}=Particle concentration steady state from the drive without filter (particles/cm³).

The above formula provides the filter cleanup time constant τ_{f}, which estimates the time to reach a 63.2% reduction from the initial particle concentration in the air. However, it has become standard practice to report the time to reach 90% reduction in particle concentration, which is equal to 2.3 time constants. It is also standard practice to report the time in seconds, so the T₉₀ cleanup time is calculated by the following equation:

T₉₀=τ_{f}×60×2.3

The T₉₀ results in Table 1 were tested using a 2.5″ drive with a volume of 22 cm³. The disk drive operates three stacked disks at 10,000 RPM. The flow rate Q was 30 cm³/min and the target input concentration (C_{a(w}_{_}_{filter)} and C_{a(w/o}_{_}_{filter)}) was 83 particles/cm³. As reflected in Table 1, the second example recirculation filter had slightly improved filter cleanup time T₉₀ than the first example recirculation filter by about 1%. The third example recirculation filter had a filter cleanup time T₉₀ that was about 10.5% greater than the first example recirculation filter. Various embodiments of filters consistent with the technology disclosed herein will have a PCU time T₉₀ that is no more than 15% greater than a similarly-sized filter element having an adsorbent element consistent with that of the first example recirculation filter, where the term “similarly-sized” is defined as a filter element having an equivalently-sized active filter area.

The three example recirculation filters were also subjected to a chemical clean-up test (CCU). In each CCU test, the tested recirculation filter was positioned in the same type of disk drive as that used in the PCU testing, described above. A flow of 30 cc/min of nitrogen with 140 ppm of trimethyl pentane (TMP) was injected into the drive through an injection port in the cover of the disk drive. Air samples were drawn from the drive through a 3 mm sampling port in the drive cover that was about 5 mm upstream of the recirculation filter and on the outer diameter of the disk. “Upstream” of the recirculation filter is considered to be opposite of the direction of disk rotation (since spinning the disk is the main driver of airflow within the drive). The injection port was positioned oppositely to the sampling port with respect to the disk drive housing.

A TMP mixed standard at 525 PPM is used that consists of TMP mixed with nitrogen in a high pressure gas tank and is available through specialty gas suppliers like Praxair. The TMP standard is run through a pressure regulator and then run into a Mass Flow Controller (MFC) by Sierra Instruments based in Monterey, Calif. to regulate the mass flow to the equivalent of 8 cc/min at standard conditions of 22.1 Celsius and 1 Atm. A second TMP free flow of nitrogen is run through a regulator and MFC to provide a mass flow equivalent to 22 cc/min at standard conditions and combined with the first flow to give a diluted flow of 30 cc/min at 140 PPM.

The TMP/nitrogen flow is first run through a switching valve to a Gas Chromatograph (GC) with the column removed, which is equipped with a Flame Ionization Detector (FID) supplied by Shimadzu Corporation based in Kyoto, Japan. The voltage output from the FID is recorded at the 140 PPM input concentration and this is used to generate a linear correlation of TMP concentration to voltage. The switching valve then directs the TMP/nitrogen flow into the injection port and the output flow from the sampling port is directed to the GC/FID. Preceding data collection, the TMP/nitrogen is run through the drive for 10 minutes before running the disk drive to allow for the gas flow to stabilize and to purge the drive and hose lines. The disk drive is then turned on to spin up the disks and the TMP concentration is measured at particular time intervals once the disks are spinning at full speed.

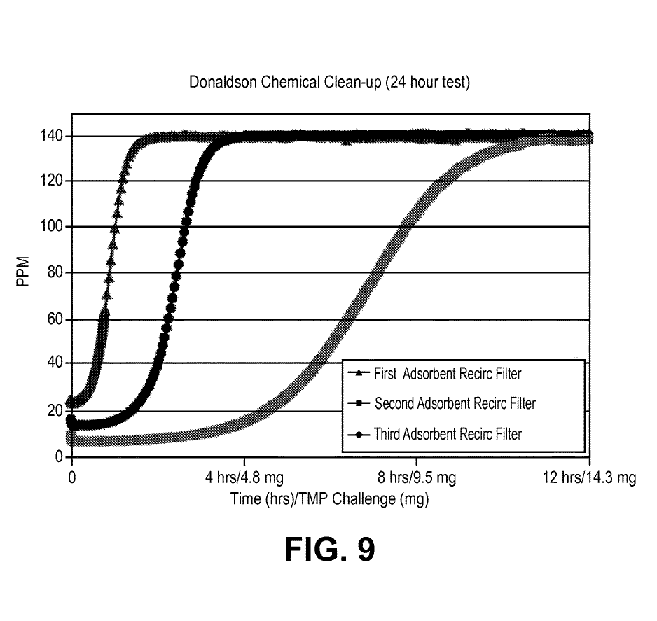

The CCU results of the three example filters tested are shown in FIG. 9, where the PPM concentration of TMP in the drive is shown over time. FIG. 9 also depicts the relationship between the concentration of TMP in the drive with the amount of the TMP challenge (mg), where “TMP challenge” refers to the amount of TMP that is sent into the disk drive. Additionally, the lowest TMP concentration was measured during each CCU test and is listed in Table 1. The lower the TMP concentration in the drive generally indicates the filter is more effective at removing the TMP. It can be desirable to have the TMP concentration stay relatively low, which can be an indication that the filter has a larger capacity for adsorbing contaminates. The CCU performance results for the three example recirculation filters shown in FIG. 9 demonstrate the CCU effectiveness of the added carbon mass and increased carbon cross-sectional area as compared to the first recirculation filter.

Some filters consistent with the technology disclosed herein have a relatively increased density of adsorbent over the adsorbent face area compared to previous technologies. For example, in some embodiments recirculation filters consistent with the technology disclosed herein have an adsorbent density of greater than 600 g/m² over the adsorbent face area. In some other embodiments, recirculation filters consistent with the technology disclosed herein have an adsorbent density of greater than 650 g/m² or even greater than 700 g/m² over the adsorbent face area. In addition, some filters consistent with the technology disclosed herein have a relatively increased density of adsorbent over the active filter face area compared to previous technologies. For example, in some embodiments recirculation filters consistent with the technology disclosed herein have an adsorbent density of greater than 250 g/m² over the active filter face area. In some other embodiments, recirculation filters consistent with the technology disclosed herein have an adsorbent density of greater than 300 g/m², 350 g/m², 400 g/m², or even greater than 450 g/m² over the active filter face area. For purposes of calculating the adsorbent density over the carbon face area or active filter area, the mass of scrims, binders, adhesives, and other substances are excluded from the mass of the adsorbent. As described above, in various embodiments the adsorbent is a plurality of activated carbon beads.

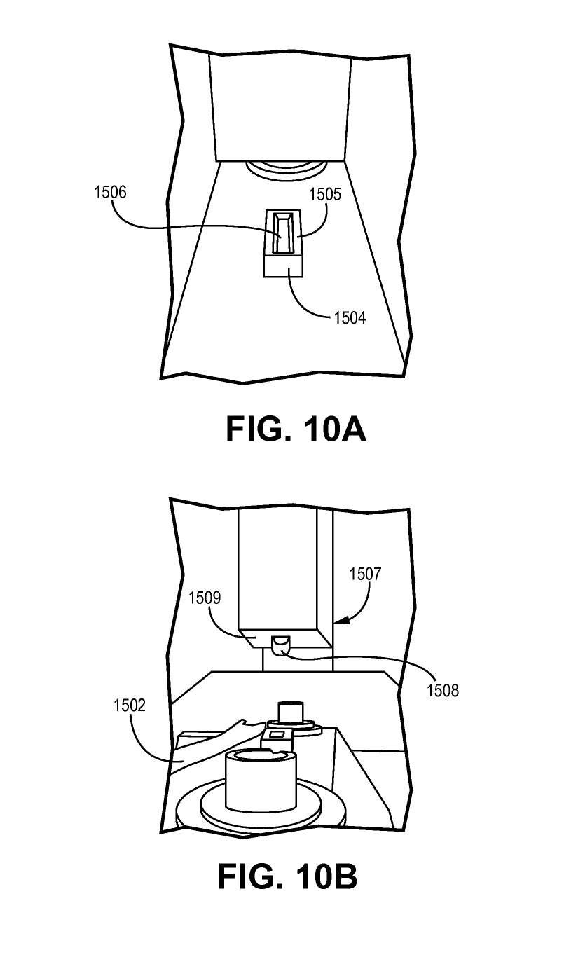

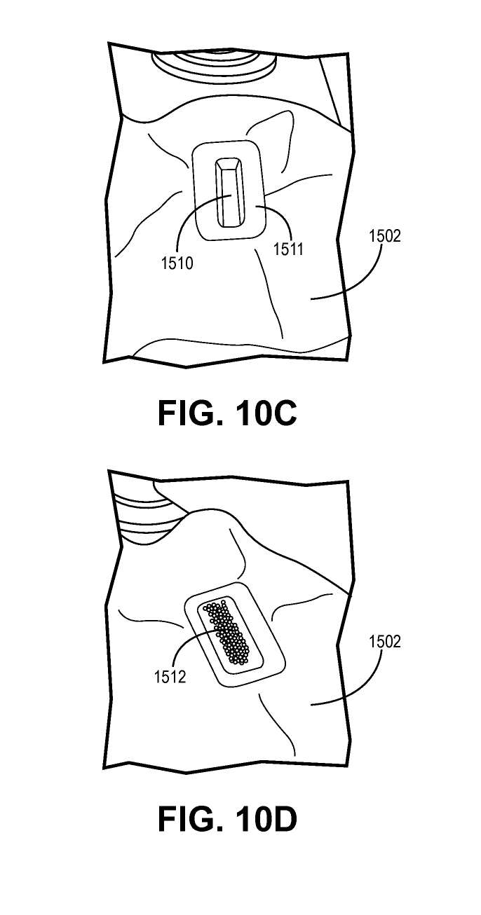

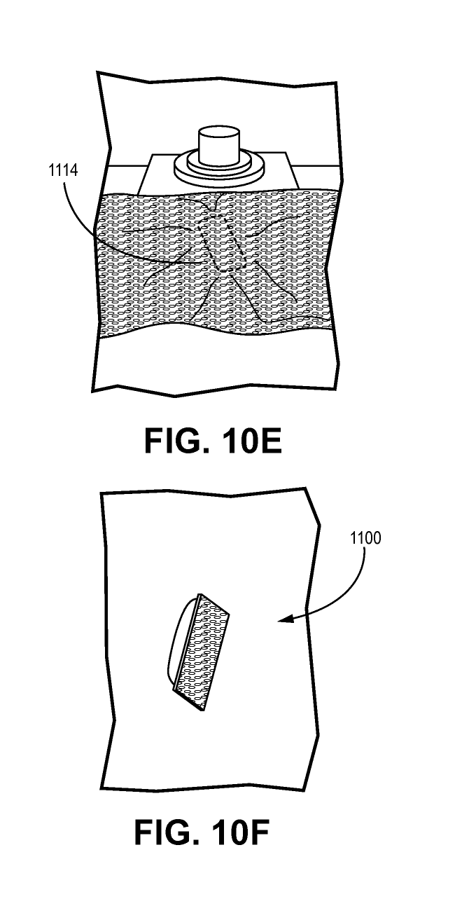

FIGS. 10A-10E are schematic depictions showing a method of making a filter assembly. The method can comprise the use of a first mating structure 1504 (shown in FIG. 10A). The first mating structure 1504 defines a perimeter 1505 and a cavity 1506 recessed from the perimeter 1505. The cavity 1506 can be configured to the desired shape of a finished filter, or can be configured to the desired shape of the filter media during manufacturing only, which will be described in more detail, herein.

A first sheet of filter media 1502 can be placed between the first mating structure 1504 and a second mating structure 1507 (shown in FIG. 10B), where the second mating structure 1507 defines a protrusion 1508 configured for mating engagement with the cavity 1506. Additional support layers and/or filter media layers can be coupled to the first sheet of filter media 1502, in some embodiments. In the current embodiment, the second mating structure defines a secondary surface 1509 that is configured for mating engagement with the perimeter 1505 of the first mating structure 1504. Those having skill in the art will appreciate that the term “mating engagement” can encompass configurations where there is a clearance between the corresponding mating structures.

The second mating structure 1507 can be translated, such that it is at least partially disposed within the cavity 1506 and the first sheet of filter media 1502 is compressed between the first mating structure 1504 and the second mating structure 1507. Upon compression between the first mating structure 1504 and the second mating structure 1507, the filter media 1502 will generally define and retain, under atmospheric gravitational forces and absent opposing external forces, a cavity structure 1510 and a rim region 1511 about the perimeter of the cavity structure 1510 similar to the first and second mating structures 1504, 1507 (shown in FIG. 10C). In some embodiments, either the perimeter 1505 of the first mating structure 1504, the secondary surface 1509 of the second mating structure 1507, or both, can be configured to melt material in the rim region 1511 of the first sheet of filter media 1502. The rim region 1511 can then be cooled to harden the melted material to increase its rigidity. In one particular embodiment, the secondary surface 1509 of the second mating structure 1507 is coupled to an ultrasonic welder that is used to melt the rim region 1511. Other types of welders are also contemplated, as will be appreciated.

With the second mating structure 1507 removed from the cavity 1506, an adsorbent 1512 can be disposed within the cavity structure 1510 (shown in FIG. 10D). In a variety of embodiments, the adsorbent 1512 is a plurality of adsorbent beads. In one particular embodiment, the adsorbent 1512 is a plurality of activated carbon beads. In an embodiment the adsorbent occupies at least 50% of the cavity. In alternative embodiments, the adsorbent can occupy at least 50%, 60%, 70%, 75%, 80%, 85%, 90%, 95%, or 99% of the cavity structure 1510.

In a variety of embodiments, a partial vacuum is created within the cavity structure 1510 of the first sheet of filter media 1502 and the adsorbent beads are disposed within the cavity structure 1510 while the partial vacuum is within the cavity structure 1510. The partial vacuum can have a number of advantages, such as preventing contamination of the manufacturing environment by containing dust from the adsorbent beads 1512 within the cavity structure 1510, increasing the number of adsorbent beads 1512 that enter and remain in the cavity, and the like. In one example method, a vacuum station can be used that defines an airflow pathway there through, and the first sheet of filter media 1502 can be placed adjacent the vacuum station such that the airflow pathway would extend from the cavity through the vacuum station. Airflow can then be generated from the cavity through the vacuum station, thereby creating a partial vacuum.

The eventual perimeter region of a second sheet of filter media 1114 is coupled to the rim region 1511 of the first sheet of filter media 1502 to contain the adsorbent beads 1512, between the first sheet of filter media 1502 and second sheet of filter media 1114 (FIG. 10E). In one embodiment the second sheet of filter media 1114 is a screen layer that is disposed across one side of the cavity. In some other embodiments, the second sheet of filter media 1114 is the same material or combination of materials as the first sheet of filter media 1502. The second sheet of filter media 1114 can be welded to the rim region 1511 of the first sheet of filter media 1502. Excess material can be trimmed away from the filter, resulting in the filter 1100 (shown in FIG. 10F).

In some embodiments the second sheet of filter media can be formed similarly to the first sheet of filter media, using a process similar to that described above. In particular, the second sheet of filter media can have a second perimeter region and can be compressed between a first mating structure and a second mating structure to define a cavity recessed from the second perimeter region. In such an embodiment the perimeter region of the first sheet of filter media and the second perimeter region of the second sheet of filter media can be bonded to form a rim region to encase a plurality of adsorbent beads disposed therein. In some such embodiments, the shape of the second sheet of filter media can be substantially similar to the shape of the first sheet of filter media. As such, the resulting filter can be a substantially symmetrical part.

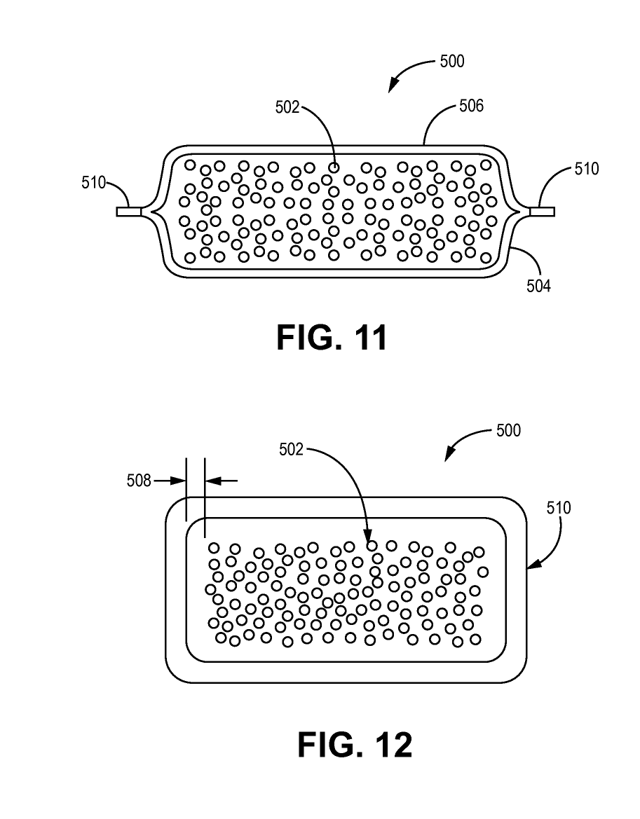

An example filter 500 consistent with the above alternative embodiment is depicted in FIGS. 11 and 12, which has a first sheet of filter media 504, a second sheet of filter media 506, and an adsorbent 502 disposed between the first sheet 504 and the second sheet 506 of filter media. The first sheet of filter media 504 is substantially symmetrical to the second sheet of filter media 506, and they are bonded around their perimeters in a rim region 510. Each of the first sheet of filter media 504 and the second sheet of filter media 506 define a cavity that is recessed from their respective perimeters. In some embodiments each of the cavities are substantially self-supporting. Each respective cavity can be formed by compressing each sheet between two structures to deform each sheet of media in the desired configuration.

In some alternate examples consistent with the technology disclosed herein, the steps of the above method associated with compressing the first sheet of filter media can be omitted. The filter embodiment depicted in FIGS. 6-7 can be consistent with such a method. In such an example method, the first sheet of filter media can be placed over a die, where the die defines a perimeter and cavity that is recessed from the perimeter similar to that depicted in FIG. 10A. A partial vacuum can be created in the cavity of the die, which can flex the first sheet of filter media towards the cavity and also create a partial vacuum on the surface of the filter media. While there is a partial vacuum within the cavity, adsorbent beads can be disposed on the first sheet of filter media. As described above, a substantial portion of the adsorbent beads can be unbonded.

In an alternate embodiment to the above paragraph, the first sheet of filter media would not flex towards the cavity of the die in response to the presence of a partial vacuum, so as to define a cavity, and would remain relatively flat. And, in some alternate embodiments, the first sheet of filter media can be placed over a relatively flat surface of a vacuum station rather than a die, where the relatively flat surface defines one or more openings to allow airflow there-through. A partial vacuum can be created through the one or more openings, thereby creating a partial vacuum on the surface of the first sheet of filter media which may or may not cause the first sheet of filter media to flex. Adsorbent beads can be disposed on the surface of the first sheet of filter media, and the location of the partial vacuum can aid in positioning the adsorbent beads central to the intended perimeter region of the first sheet of filter media.

After disposing the adsorbent beads on the first sheet of filter media, a second sheet of filter media can be coupled to the first sheet of filter media to contain the adsorbent beads between the first sheet of filter media and the second sheet of filter media. The first sheet of filter media and the second sheet of filter media can be bonded by melting the sheets of filter media together in a rim region surrounding the adsorbent beads. In one particular embodiment, the second sheet of filter media can be melted to the filter sheet of filter media in the rim region. A filter assembly that is constructed consistently with the above method can have a first sheet of filter media and a second sheet of filter media that is substantially symmetrical in some embodiments (such as that depicted in FIG. 6-7 or 11-12). In other embodiments the first sheet of filter media and the second sheet of filter media will be merely more symmetrical than the embodiment depicted in FIG. 4, for example.

In some alternate examples consistent with the technology disclosed herein, the steps of the above-described methods associated with using a vacuum can be omitted. Furthermore, in some embodiments it can be desirable to bond a portion of the perimeter region of the first sheet of filter media with a portion of the perimeter region of the second sheet of filter media and insert substantially unbonded adsorbent beads in the cavity defined among the first sheet of filter media, the second sheet of filter media, and the bonded portion of the perimeter regions of the first sheet and second sheet. In some embodiments a partial vacuum can be established in the cavity during the insertion of the adsorbent beads. In some other embodiments no partial vacuum is established in the cavity during the insertion of the adsorbent beads. Subsequent to insertion of the adsorbent beads, the remaining unbonded perimeter regions of each of the first sheet of filter media and the second sheet of filter media can be bonded to form a cohesive rim region about the filter.

In one alternate embodiment, the first sheet of filter media and the second sheet of filter media can be defined by a single sheet of filter media, and the method of forming a filter element can have a step of folding the second sheet of filter media relative to the first sheet of filter media to define a fold along one edge of the perimeter region of the resulting filter element. In such a method the unbonded portions of the perimeter regions of the first and second sheets of filter media can be bonded as described herein to form a rim region that extends around at least a portion of the perimeter of the resulting filter element. In some other embodiments it can be desirable to melt material of the first and/or second sheets of filter media together along the fold to increase rigidity. In such embodiments the rim region can extend about the entire perimeter of the resulting filter element. Other embodiments are also contemplated.

The above specification provides a complete description of the manufacture and use of the currently-described technology. Since many embodiments can be made without departing from the spirit and scope of the currently described technology, such technology resides in the claims hereinafter appended.

1-17. (canceled)

18. A method of making a filter assembly comprising:
placing a first sheet of filter media between a first mating structure and a second mating structure, wherein the first mating structure defines a perimeter and a cavity recessed from the perimeter and the second mating structure defines a protrusion configured for mating engagement with the cavity;
compressing the first sheet of filter media between the first mating structure and the second mating structure such that the first sheet of filter media defines and retains a cavity structure and a rim region about the perimeter of the cavity;
creating a partial vacuum within the cavity of the first sheet of filter media;
disposing adsorbent beads within the cavity of the first sheet of filter media while the partial vacuum is within the cavity of the first sheet of filter media; and
coupling a perimeter region of a second sheet of filter media to the rim region to contain the adsorbent beads between the first sheet of filter media and the second sheet of filter media.

19. The method of claim 18, wherein the first sheet of filter media comprises a first layer of filter media and a second layer of scrim material.

20. The method of claim 18, wherein the adsorbent beads comprise activated carbon beads.

21. The method of claim 18, wherein creating a partial vacuum within the cavity comprises:
placing the first sheet of filter media on a vacuum station defining an airflow pathway from the cavity through the vacuum station; and
generating airflow from the cavity into the vacuum station.

22. The method of claim 18, wherein coupling the second sheet of filter media to the rim region comprises welding the second sheet of filter media to the rim region of the first sheet of filter media.

23. The method of claim 18, wherein the first sheet of filter media has a permeability of between about 250 ft./min. at 0.5 inches of water and about 750 ft./min. at 0.5 inches of water.

24. The method of claim 18, wherein the adsorbent beads have an average size of 0.4 mm to 0.8 mm.

25. The method of claim 18, further comprising increasing the rigidity of the rim region by melting the rim region of the first sheet of filter media and then cooling the rim region of the first sheet of filter media.

26. The method of claim 18, wherein the first sheet of filter media and the second sheet of filter media are different materials.

27. The method of claim 18, wherein the first sheet of filter media and the second sheet of filter media are the same materials.

28. A method of making a filter assembly comprising:
placing a first sheet of filter media over a die defining a perimeter and a cavity recessed from the perimeter;
creating a partial vacuum within the cavity of the die;
disposing adsorbent beads on the first sheet of filter media while there is the partial vacuum within the cavity; and
coupling a second sheet of filter media to the first sheet of filter media to contain the adsorbent beads between the first sheet of filter media and the second sheet of filter media.

29. The method of claim 28, wherein the first sheet of filter media is substantially planar and creating a partial vacuum flexes the first sheet of filter media towards the cavity.

30. The method of claim 28, wherein a substantial portion of the adsorbent beads are unbonded.

31. The method of claim 28, wherein coupling the second sheet of filter media to the first sheet of filter media comprises melting the first sheet of filter media and the second sheet of filter media together in a rim region surrounding the adsorbent beads.

32. The method of claim 28, wherein the coupling comprises melting the second sheet of filter media to the first sheet of filter media in the rim region.

33. The method of claim 28, wherein the adsorbent beads comprise activated carbon beads.

34. The method of claim 28, wherein creating a partial vacuum within the cavity comprises:
generating airflow across the first sheet of filter media into the cavity.

35. The method of claim 28, wherein the first sheet of filter media has a permeability of between about 250 ft./min. at 0.5 inches of water and about 750 ft./min. at 0.5 inches of water.

36. The method of claim 28, wherein the first sheet of filter media and the second sheet of filter media are different materials.

37. The method of claim 28, wherein the first sheet of filter media and the second sheet of filter media are the same materials.

38-49. (canceled)
